(19) United States
(12) Patent Application Publication
(10) Pub. No.: US 2006/0175841 A1
(43) Pub. Date: Aug. 10, 2006

(54) Electrically operated door opener

(76) Inventors: Augustin Toma, Balingen (DE); Rudolf Schnekenburger, Deilingen (DE); Peter Jelitto, Balingen (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/522,583

(22) PCT Filed: Sep. 15, 2004
(86) PCT No.: PCT/EP04/10356

§ 371 Date: Feb. 28, 2006

(30) Foreign Application Priority Data
Dec. 20, 2003 (DE) 103 60 225.9

(51) Int. Cl. E05C 3/02; G08B 21/00

(52) U.S. Cl. 292/240; 340/686.1

(57) ABSTRACT

An electrically operated door opener, with a swivelable swing trap for blocking or releasing of a door side switch trap, with a movable control lever, and a change-over, has been described, which can move into a position that blocks the swing trap and into a position that releases the swing trap, and is so arranged with the control lever, that the change-over into the blocking position can be locked by means of the control lever. Furthermore, there is a position indicator for moving the control lever for releasing or locking the change-over. The position indicator has an electromotor, on the motor axis of which an eccentric cam is mounted. The electromotor is mounted with a control lever, so as to hit the centrifugal cam against the control lever on activation of the electromotor due to the rotation of the motor axis, causing the control lever thereby to move.

The invention relates to an electrically operated door opener.

Electrically operated door openers have been known for a long time. They usually have a swing trap, in which, in the locked condition, a spring trap is actuated and is held there. In the released condition, the swing trap can swivel against the action of an elastic force and the spring trap can thus be released. Generally, the releasing of the swing trap takes place electrically and is triggered by a person by means of buttons or automatically by means of an access control system.

Usually a linear position indicator, which has an anchor that can move electromagnetically in a linear direction, is used for releasing the door opener. In the idle state, the anchor is freely movable and can be moved under the action of impacts or vibrations acting from outside. This can lead to the door opener releasing the swing trap through manipulation from outside. Therefore, in order to prevent unauthorized access reliably, it is necessary that the electric door opener is not sensitive to impacts from outside as much as possible.

Furthermore, it is possible that the swing trap is preloaded at the time of releasing the door opener, because, for example, a person is already pressing against the door. If one tries to release the swing trap of the door opener, it can become blocked while doing so, which will prevent the swing trap from release. Therefore, it is desirable that the door opener can be released also when the swing trap is subjected to a preload.

The aim of the present invention is to devise an impact-proof and vibration-proof door opener, which can be released even when there is a preload.

This aim is achieved by the electrically operated door opener as described in claim 1.

Further advantageous designs according to the invention are described in the dependent claims.

According to the invention, an electrically operated door opener is devised, which has a swiveling swing trap for withholding or releasing a spring trap. Furthermore, a movable catch lever and a change-over are provided, which can be moved between a position blocking the swing trap and a position releasing the swing trap. The change-over is mounted on the catch lever in such a way that the change-over can be locked by means of the catch lever in the blocking position. The catch lever can be moved with the help of a position indicator in order to lock or to release the change-over. The position indicator has an electric motor, on the motor axis of which a centrifugal cam is arranged. The electric motor is arranged with the catch lever, in order to strike the centrifugal cam, following activation of the electric motor due to the rotation of the motor axis, against the catch lever, so that the counterbalanced catch lever is moved.

An advantage of the invention is that the electrically operated door opener is not sensitive to the effect of the impacts and vibrations, because an electric motor is used in lieu of a linear position indicator to operate the door opener. Electric motors can in general not be brought to rotate by impacts or hits, particularly not, with such rotational speeds, which are necessary for driving the centrifugal cam. The use of the centrifugal cam has the advantage that the impulse, with which it strikes against the catch lever, can be set virtually arbitrarily by means of the motor speed, so that, even against a heavy preload on the swing trap, and hence on the change-over, it is possible to unlock the change-over and thus to release the swing trap. Since the catch lever is counterbalanced about the rotation axis, even here the impacts or the hits do not lead to any dynamic movement. Consequently, the system is not sensitive to the effects of the impacts and vibrations.

The catch lever can preferably be provided with a chamfer, against which the centrifugal cam strikes in course of the rotation, so that the catch lever moves in a direction parallel to the axis of rotation. It is possible to adjust the preset distance along which the catch lever moves by setting the chamfer angle and the chamfer width.

The centrifugal cam can have one or more impact disc(s) supported by bearings on the cam axis, such that it is supported on the cam axis swivelably and rotatably in the radial direction of the axis of rotation.

The change-over can be mounted on the swing trap in such a way that the swing trap moves the change-over with its swiveling.

According to another embodiment, the change-over is constructed essentially in an L-shaped form. Thereby, a first change-over shank is coupled with the swing trap, so that the first change-over shank moves with the swiveling of the swing trap. A second change-over shank can also be coupled with the catch lever, whereby on locking of the change-over, the second change-over shank is locked by the catch lever, so that a movement of the change-over is prevented during the swiveling of the swing trap.

The second change-over shank preferably has a first holding element, which is held, on locking by the catch lever, with a second holding element of the catch lever, and which does not interact with the second holding element on releasing.

The catch lever can rest swivelably on a swing axis. Thereby, the catch lever is arranged in such a way that the second change-over shank exerts a force in the direction of the swing axis on locking with the catch lever and using a swiveling force on the swing trap.

In particular, the swing trap can be coupled with the first change-over shank in a way that on exercising a swiveling force on the swing trap, a leverage is exerted on the first change-over shank, whereby, when releasing using the catch lever, the leverage on the change-over leads to the swiveling of the change-over.

For that purpose, the first change-over shank can have a slope, on which a part of the swing trap rests, so that during swiveling of the swing trap, the part slides along the slope and thus a leverage is applied on the first change-over shank. In particular, the first change-over shank is smaller than the second change-over shank.

It can be so built that the change-over is coupled with a spring element so that the first change-over shank presses against the part of the swing trap.

Preferably, the second change-over shank is built with respect to the swing trap in such a manner that, with the swiveling of the swing trap, the second change-over shank moves in the direction of the swing trap, if the change-over is released by the catch lever.

In another embodiment, the electric motor can be electrically contactable through a terminal block, whereby the terminal block can be fastened at several positions of the housing of the door opener.

The feedback to a headquarter, about whether the door side spring trap is engaged in the swing trap, can take place with only one single operating lever in combination with an adjustable swing trap.

A preferred design of the invention is explained further in the following with the help of the attached illustrations. Following schematic figures are shown:

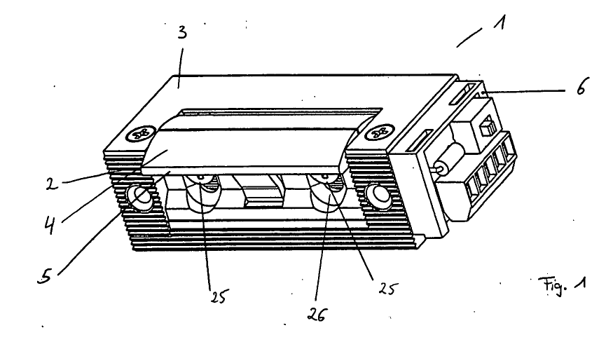

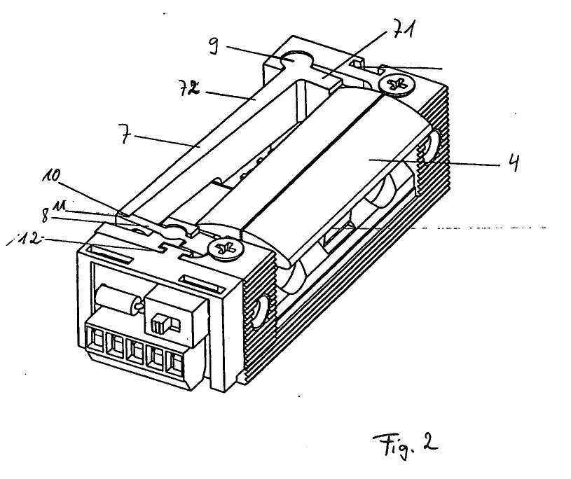

FIG. 1 An overall view of the door opener according to the invention;

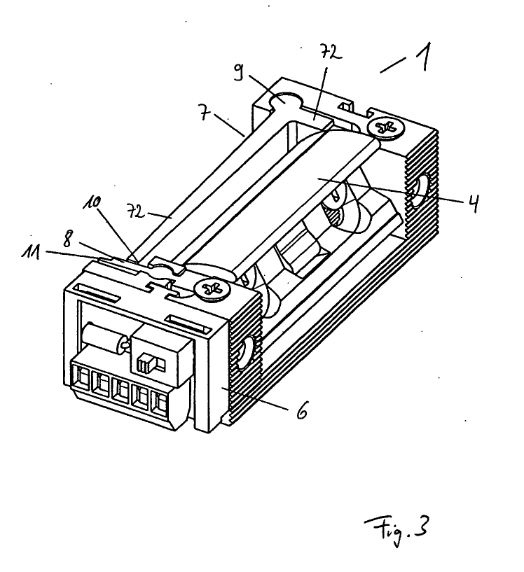

FIG. 2 A perspective view of the door opener according to FIG. 1 without the housing plate (cover);

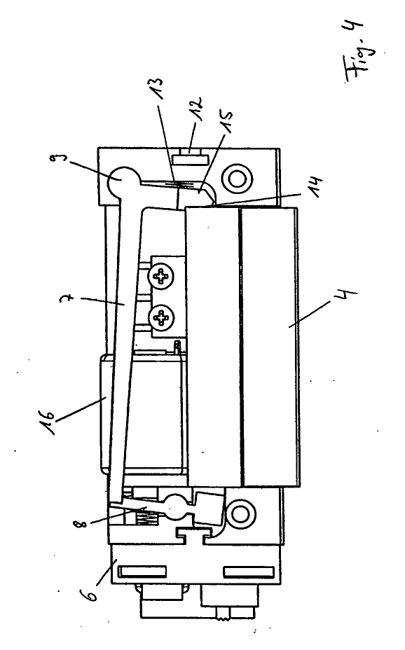

FIG. 3 A perspective view of the door opener according to FIG. 1 with swiveled swing trap;

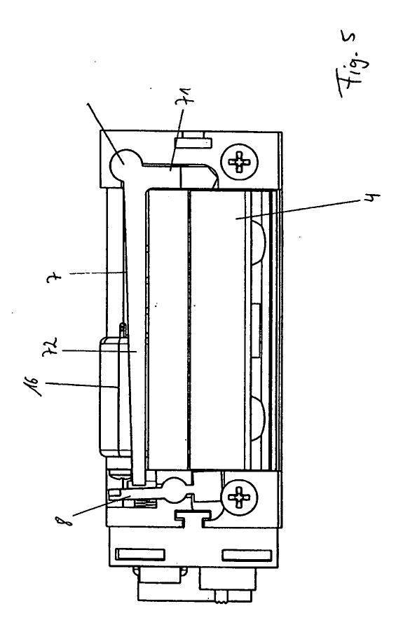

FIG. 4 A top view of the door opener in locked condition;

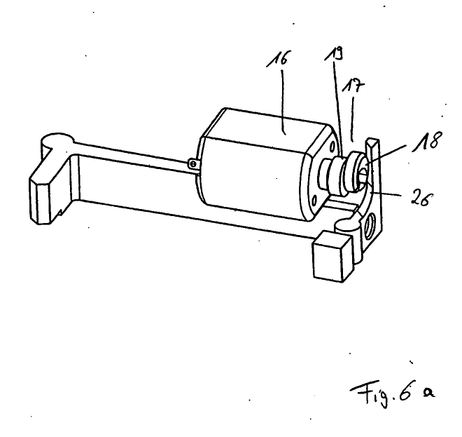

FIG. 5 A top view on the door opener in released condition;

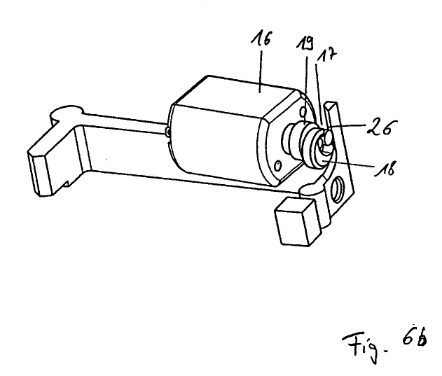

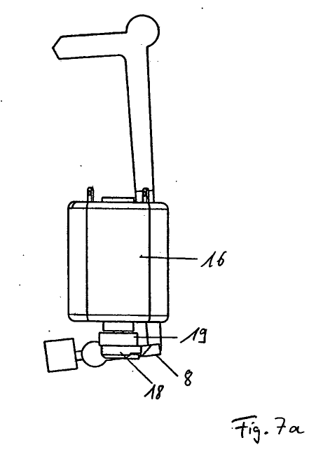

FIG. 6a, b The lock unit for the door opener in different rotor positions;

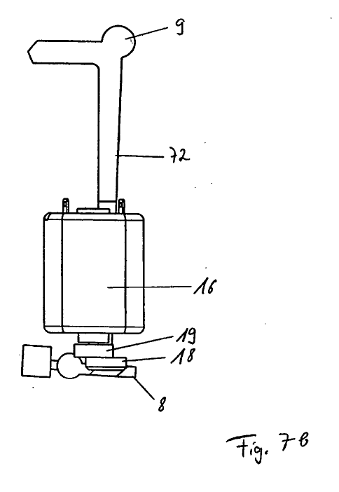

FIG. 7a, b Another view of the lock unit for the door opener in different rotor positions according to the invention;

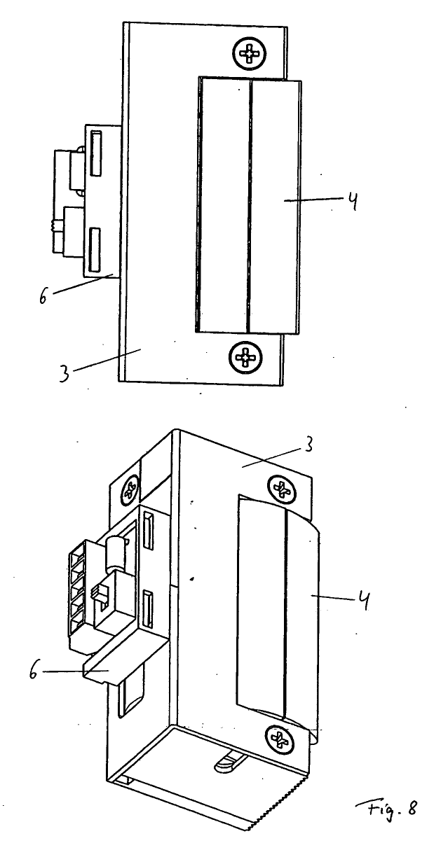

FIG. 8 An overall view of another design of the door opener with a terminal block;

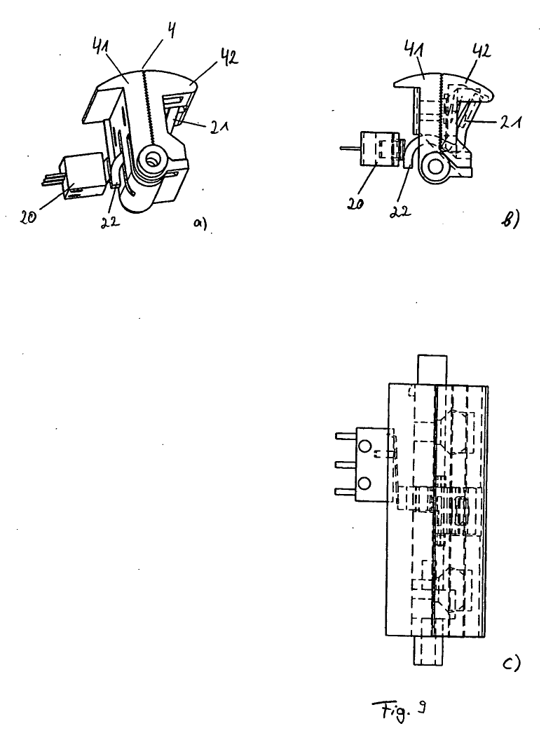

FIGS. 9 a)-c) Different views of the swing trap with a microswitch according to another embodiment of the invention; and

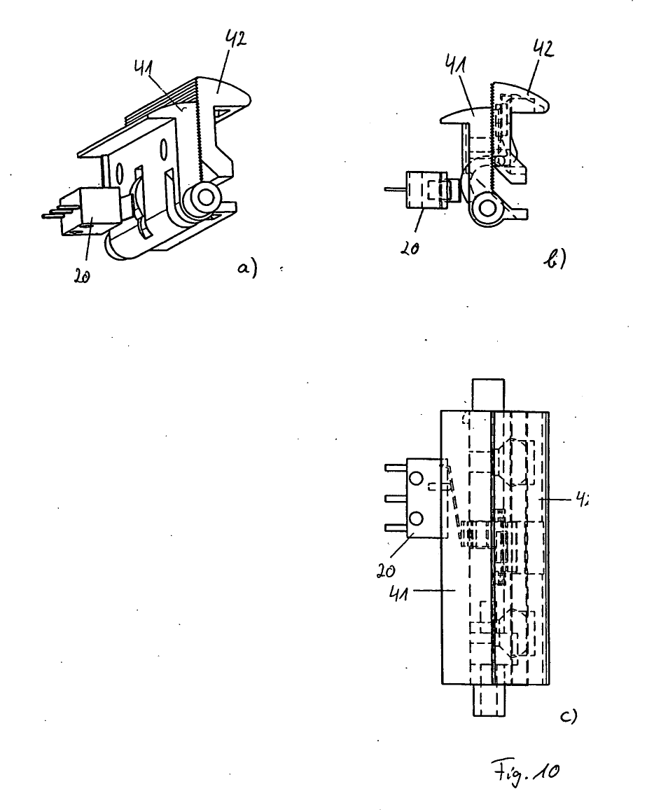

FIGS. 10 a)-c) Different views of the swing trap with a microswitch according to the embodiment as in the FIGS. 9 a), c), with an adjusted swing lever.

In FIG. 1, an electrically operable door opener 1 is shown according to the first embodiment of the invention. Usually, the door opener 1 is permanently built in a doorframe. It has a housing 2, on which a cover plate (cover) 3 is attached with the help of screws, so as to shut the interior of the door opener 1. The door opener includes a swing trap 4 that is held against an elastic force swivelably around a swing trap axis in the housing 2 and can swivel in the direction of the interior of the housing. The swing trap 4 is shown in the starting position and serves the purpose of holding or releasing the spring trap (not shown here) mounted on the door etc. For that purpose, the swing trap 4 is provided with a jut 5, behind which the spring trap can lock.

On the side panel of the housing 2, a terminal block 6 is provided, by means of which the electrical connection can be established using the position indicator provided in the door opener.

In FIGS. 2 and 4, the door opener 1 is shown in various views, without the cover plate, in which the change-over 7 is in the blocked position. The change-over 7 can be detected in the interior of the housing 2, which has two change-over arms 71 and 72. The first and the second change-over arms 71 and 72 are arranged at a right angle to each other. The change-over is attached swivelably on a change-over axis 9 so that the change-over can be swung.

In FIGS. 2 and 4, the change-over is shown in a position blocking the swing trap 4. The first change-over arm 71 is oriented in the direction of the swing trap 4, so that, supported by the change-over axis 9, it hinders the swiveling of the swing trap 4 in the direction of the swivel.

The second change-over arm 72 is withheld from swiveling by the catch lever 8. To that end, the second change-over arm 72 has a stopping part 10 at the end lying opposite to the change-over arm axis 9, which latches onto the stage 11 at an end of the catch lever 8.

The terminal block 6 is fixed in the housing 2 by means of T-shaped slot 12 provided at several sides of the housing 2 or in the cover 3. The terminal block 6 has a T-shaped holding element in its rear side, which is designed in such a way that it can be inserted into the slot 12. The terminal element 6 is thus kept fixed on the housing 2. However, it is also possible to provide several locations for the terminal element 6 in the housing 2 by means of several T-shaped slots 12, so that the door opener 1 can be constructed with different configurations.

The FIGS. 3 and 5 show different views of the door opener 1 in releasing position, in which the swing trap 4 is swiveled to release the spring trap (not shown here). The change-over 7 is in the releasing position in this releasing condition of the swing trap 4. In the releasing position of the change-over 7, it is swung anticlockwise with respect to the blocking positions shown in FIGS. 2 and 4, so that the first change-over arm 71 is moved in the direction of the swing trap axis and lies besides the swung swing trap 4, so that the swing trap 4 is swung past the first change-over arm 71.

The second change-over arm 72 is now also swung anticlockwise about the swing axis 9 of the change-over 7 in the direction of the swing trap 4. Hence, the structural layout of the door opener 1 can be as compact as possible, because, in the design of the size of the housing 2, it is not necessary to take into account the possible swing of the change-over 7 away from the swing trap 4.

In order to be able to swing the change-over 7 from the blocking position to the releasing position, the catch lever 8 must be moved in such a way that the holding element 10 of the change-over 7 is no longer in the stage 11, so that the change-over 7 can be swung freely with respect to the catch lever 8. The swiveling of the change-over 7 takes place against an elastic force exerted by the spring element 13 coupled with the change-over 7. The spring element 13 exerts the elastic force on the change-over 7 in the direction of the blocking position.

The change-over 7 is moved into the releasing position by a force on the swing trap 4. The swing trap 4 yields to the tractive force acting on the jut 5, thereby swinging about the swing trap axis. To that end, the swing trap 4 has a part 14, particularly an edge or a corner, that slides along the slope 15 on the first change-over arm 71 of the change-over 7 and consequently moves the first change-over arm 71 in the direction of the swing trap axis, that is, vertically to the direction of the swing of the swing trap 4. If the tractive force weakens, the elastic force of the spring element 13 presses the first change-over arm 71 against the section 14 of the swing trap, so that the swing trap 4 swings back into its home position again, that is, into the position, in which spring trap can be withheld. The swing trap 4 can also be provided with another spring element (not shown here), arranged, for example, on the swing trap axis, which brings the swing trap 4 into the starting position on slackening of the tractive force on the jut 5.

The catch lever 8 can be moved by means of a position indicator 16, which is also provided in the housing 2 of the door opener 1. The catch lever 8 is provided with a spring element 17a, which brings the catch lever 8 into the locking position, if the change-over is in the blocking position and the position indicator 16 is not activated. The catch lever 8 remains swivelable along the catch lever axis.

Preferably, the catch lever axis is arranged in the direction of the swing of the holding element 10 of the change-over 7. Thus, a preloading of the change-over 7 in the direction of the blocking position, during the latching of the holding element 10 in the stage 11, results in a compressive force, and not in lateral and tensile forces, on the catch lever 8, so that the latter can be disengaged.

The position indicator 16 is designed as an electric motor, whose motor axis is equipped with a centrifugal cam 17. In FIGS. 6a and 6b, as well as in FIGS. 7a and 7b, different views of the change-over 7, of the catch lever 8 and of the electric motor 16 corresponding to their construction in the door opener 1, are displayed for clarification of the mechanical interplay.

The centrifugal cam 17 has an impact disk 18, which is mounted eccentrically with respect to a rotating disk 19 connected with the motor axis. The impact disk 18 is supported with bearings swivelably or rotatably on the rotating disk 19, so that with the rotation of the motor axis on activation of the electric motor 16, the impact disk 18 moves outwards due to the centrifugal force. A part of the edge of the impact disk 18 describes the largest possible orbit about the motor axis.

The catch lever 8 is arranged near the impact disk 18. In order to interact with the impact disk 18, the catch lever 8 has a chamfer 26 in the form of an area inclined to the motor axis on which the impact disk 18 slides along at least in course of a part of its orbit. The chamfer 26 is arranged at a distance from the motor axis, which is smaller than the largest possible orbit, so that the outermost edge of the impact disk 18 traverses a smaller orbit. Due to the fact that the outer edge of the impact disk 18 is pushed to traverse a smaller orbit, the impact disk 18 exerts a force on the chamfer 26 due to the centrifugal force, so that a resultant force on the catch lever 8 acts in the direction of the motor axis. The resultant force causes a movement of the catch lever 8 and swings the catch lever 8, because it is held swivelably on bearings.

If the motor stands still, the elastic force acting on the catch lever 8 presses the catch lever 8 into the locking position. Thus, the chamfer acts on the catch lever 8 so that the impact disk 18 is twisted on the rotating disk 19 in such a way that the outer edge is at the least possible distance from the motor axis. This position is displayed in FIGS. 6b and 7a.

The movement of the catch lever 8 brings it out of the locking position, so that the change-over is released on activation of the electric motor 16.

The chamfer on the catch lever 8 is preferably designed as a slope, which is inclined in the direction of the electric motor in such a way that the resultant force acts in the direction of the motor axis away from the electric motor 16. The preset distance for which the catch lever can swing at the most, on activation of the electric motor 16, can be set by adjusting the angle and the width of the slope with respect to the catch lever 8.

The chamfer 26 is preferably built in the plane vertically to the motor axis, curved in such a manner, that with each motor revolution, the impact disk 18 slides at first along the largest orbit on the chamfer 26 and then is pushed, in course of the subsequent revolutions about the rotation axis, continuously to a smaller orbit, so that the impact disk 18 is swung in a direction opposite to the direction of the rotation of the rotating disk 19. The impact of the impact disk 18 on the chamfer 26 can be reduced considerably, so that the wear of the catch lever 8 due to the impact of the impact disk 18 is reduced. The impact disk 18, at the moment when it makes an impact on the chamfer 26, is shown in FIG. 6a.

A specific impact of the impact disk 18 on the chamfer 26 is, however, advantageous.

Because, in case of a preloading of the change-over 7, due to the pressure on the jut 5 of the swing trap 4, the holding element 10 of the second change-over arm 71 presses into the stage 11 and thus braces the catch lever 8 against the change-over 7. A movement of the catch lever 8 is then possible only by overcoming the distorting force. This distorting force can be achieved by one or several impacts of the impact disk 18 on the chamfer 26. The degree, by which the orbit of the outer edge of the impact disk is reduced, due to the buckling of the chamfer 18, thus depends, among other things, on how strong the impacts on the catch lever need to be, so as to bring the catch lever 8, with the preload on the change-over 7, out of the locking condition.

In order to reduce the distorting force acting between the catch lever 8 and the change-over 7, it is advantageous to construct the second change-over arm as long as possible, so that with the preload of the swing trap 4 and the leverage acting consequently on change-over arm 71, the least possible leverage is generated at the end of the second lever arm 72.

Use of an electromotor 16 for releasing the change-over has the advantage that, in contrast to the linear position indicator, no magnetically activable anchor (counterbalanced catch lever) is present, which can be moved under the effect of impacts or vibrations, so that safety from manipulation is significantly improved.

In FIGS. 8 a) and b) a top view and a perspective view of another design of the door opener according to the invention are shown. In the design shown, there is the terminal block 6 on one of the rear side of the housing 2 opposite to the swing traps 4. Thereby the T-shaped holding element 12 is fastened into the corresponding T shaped slit (not shown) built on the rear side, so that the terminal 6 is held securely. The electrical connecting lines are introduced as separate cables between the electromotor 16 and the terminal block 6 into the interior of the housing 2.

In another design, shown in FIGS. 9 a)-c) and in FIGS. 10 a)-c), the possibility of finding out, by means of a microswitch 20, whether, in the blocking position of the swing trap 4, the swing trap 4 has latched into in the spring trap 4 or not, is demonstrated. For that, underneath the jut 5, below which the spring trap can engage, a movable element 21 is provided in the swing trap 4, which is held swivelably in the recess in the swing trap and is connected with control lever 22. When the spring trap latches below the jut 5, the movable element 5 is pressed into the recess in the direction of the swing trap 4, so that the control lever 22 makes the corresponding movement. The control lever 22 is coupled with the microswitch 20, whereby the control lever 22 activates the switch blade 23 of the microswitch 20 following engagement of the spring trap into the switch blade 23 and thus carries out the switching process. The switch can be built as a switch-over and can have two, three or more electrical connections 24.

According to another design shown in FIGS. 10 a)-c), the possibility of the adjustment of the height of the jut of the swing trap 4 is demonstrated. In particular, it is shown in FIG. 10a) that the swing trap 4 is built in two parts, containing one basic element 41 and another adjustable element 42 that is displaceable with respect to the former. The basic element 41 is firmly connected swivelably about the axis of the swing trap, while the adjustable element is held by means of the fastening screws 25 shown in FIG. 1, which are fastened in the longitudinal screw slits 26. The adjustable element 42 and the basic element 41 fit tightly at their mutual contact areas, whereby the contact areas have a number of cog like elements, which latch onto each other at different positions. By loosening the fastening screws 25, the height of the jut 5 in the adjustable element 42 can be adjusted, whereby the adjustable element is displaced with respect to the basic element 41, so that the height of the jut 5 can be adjusted through the door opener. By tightening the fastening screws 25, the adjustable element 42 can be fixed on the basic element 41.

1. Electrically operated door opener with a swivelable swing trap for blocking or releasing a spring trap, with a movable catch lever, with a change-over, which can be moved into a position blocking the swing trap and a position releasing the swing trap, and
which is so arranged with the catch lever, that the change-over can be locked in the blocking position by means of the catch lever;
with a position indicator for moving the control lever, for locking or releasing the change-over;
characterized in that
the position indicator comprises of an electromotor, at the motor axis of which, a centrifugal cam is mounted, whereby the electromotor is arranged with the control lever, so as to hit the centrifugal cam against the control lever on activation of the electromotor due to the rotation of the motor axis, thereby causing the control lever to move.

2. Door opener according to claim 1,
characterized in that
the control lever has a chamfer against which the centrifugal cam hits on rotation, so as to thereby move the control lever in the direction parallel to the axis of rotation.

3. Door opener according to claim 1,
characterized in that
the centrifugal cam has an eccentrically supported impact disc with an external axis, which is supported on the centrifugal axis swivelably and rotatably in the direction of the axis of rotation.

4. Door opener according to claim 1,
characterized in that
the control lever is held swivelably.

5. Door opener according to claim 1,
characterized in that
the change-over is mounted with the swing trap, so as to move the change-over on swiveling of the swing trap.

6. Door opener (1) according to one of the claims 1 to 5,
characterized in that
it has essentially an L-shaped form, whereby a first change-over shank is coupled with the swing trap, so as to move the change-over on swiveling of the swing trap, and
whereby a second change-over shank can be coupled with the control lever, whereby on locking of the change-over, the second change-over shank is locked by the control lever, so that a movement of the change-over is hindered on swiveling of the swing trap.

7. Door opener according to claim 6,
characterized in that
the second change-over shank has a first holding element, which is held with a second holding element of the control lever on locking, and which does not interact with the second holding element on releasing.

8. Door opener according to claim 7,
characterized in that
the control lever is held swivelably, whereby the control lever is so arranged that, on locking by the control lever and on exertion of a swiveling force on the swing trap, the second change-over shank exercises a force on the control lever in the direction of the axis of the swing.

9. Door opener according to claim 6,
characterized in that
the swing trap is coupled with the change-over shank in such a fashion, that on application of an opening force on the swing trap, a leverage is exercised on the change-over shank, whereby the leverage leads, on releasing by the control lever, to swiveling of the change-over.

10. Door opener according to claim 9,
characterized in that
the first change-over shank has a slope, against which a part of the swing trap rests, so that on swiveling of the spring trap, a leverage acts on the first change-over shank.

11. Door opener according to claim 10,
characterized in that
the change-over is coupled with a spring element, so as to press the first change-over shank against the part of the swing trap.

12. Door opener according to claim 6,
characterized in that
the first change-over shank is smaller than the second change-over shank.

13. Door opener according to claim 7,
characterized in that
the second change-over shank is arranged with respect to the swing trap in such a manner as to move, on swiveling of the swing trap, the second change-over shank in the direction of the swing trap, if the change-over is released by the control lever.

14. Door opener according to claim 1,
characterized in that
the electromotor can be contacted by means of a terminal block, whereby the terminal block can be fastened at several points of the housing 2 of the door opener.

15. Door opener according to claim 1,
characterized in that
the swing trap is constructed of two parts comprising of one basic element, and one adjustable element displaceable with respect to the former, and that a movable element is provided on the swing trap, which stands in effective connection with a microswitch, so as to detect the latching of the door-side spring trap into the swing trap.
